(19) United States
(12) Patent Application Publication
(10) Pub. No.: US 2004/0102580 A1
(43) Pub. Date: May 27, 2004

(54) Rubber composition for solid golf ball, method of producing core for solid golf ball, and golf ball

(75) Inventors: Nobuyuki Kataoka, Chichibu-shi (JP); Hiroshi Higuchi, Chichibu-shi (JP); Atsushi Nanba, Chichibu-shi (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: BRIDGESTONE SPORTS CO., LTD.

(21) Appl. No.: 10/422,902

(22) Filed: Apr. 25, 2003

(30) Foreign Application Priority Data
Nov. 22, 2002 (JP) 2002-339471

(51) Int. Cl. C08F 8/00; C08C 19/00

(52) U.S. Cl. 525/332.5

(57) ABSTRACT

A rubber composition for a solid golf ball contains a polybutadiene rubber component, a co-crosslinking agent, an organic peroxide, a filler, and an organic sulfur compound. When a core for a solid golf ball is formed by using the rubber composition for a solid golf ball, the content of a trans-structure in a cross-linked polybutadiene rubber component on the surface of the core is in a range of 20 to 39%, and a value obtained by subtracting the content of the trans-structure in the cross-linked polybutadiene rubber component at the center of the core from the content of the trans-structure in the cross-linked polybutadiene rubber component on the surface of the core is in a range of 5 to 35%. A solid golf ball produced by using such a core is excellent in hit feeling and flight characteristics. A method of producing a core for a solid golf ball makes it possible to simply produce the core specified as described above.

### BACKGROUND OF THE INVENTION

The present invention relates to a rubber composition for a solid golf ball, which is used for producing a golf ball having high initial speed (rebound) as well as soft hit feeling with good productivity.

Golf balls having various structures are now being put into market, among which golf balls for competition are generally classified into solid golf balls such as two-piece golf balls and thread-wound golf balls. Solid golf balls excellent in flight characteristic and durability as compared with thread-wound golf balls hold a majority of the market share; however, such solid golf balls are disadvantageous in hard hit feeling and large impact, and are inferior to thread-wound golf balls in controllability.

To obtain hit feeling close to that of a thread-wound golf ball, a so-called soft type solid golf ball has been proposed; however, such a soft type solid golf ball has another disadvantage. Namely, the use of a soft core, which is essential to obtain the soft type solid golf ball, reduces the rebound characteristic of the golf ball, to degrade the feature of the solid golf ball, that is, shorten the flight distance, and to reduce the durability. User's demands lie in carrying a golf ball further away while keeping soft hit feeling, and to meet such demands, it is expected to develop a golf ball capable of enhancing the initial speed (rebound) while keeping soft hit feeling.

A solid golf ball having a core and a cover directly covering the core or covering the core via an intermediate layer has been proposed in Japanese Patent Laid-open No. Hei 8-98901. The core is obtained by vulcanizing a rubber composition containing, as a main rubber component, polybutadiene rubber having 90% or more of a cis-structure before vulcanization. In this core, a trans-structure after vulcanization is in a range of 10 to 30%, and the hardness, measured by a JIS-C hardness meter, of the core is specified such that the difference between the hardness at the center of the core and each of the hardnesses measured at intervals of 5 mm in the direction from the center of the core to the surface of the core is in a range of 10% or less. The solid golf ball, however, has a room for improvement in terms of rebound.

A solid golf ball having one or more core layers and one or more cover layers has been proposed in Japanese Patent Laid-open No. 2000-185115. The innermost core layer is formed by vulcanizing a rubber composition containing 100 parts by weight of a main rubber component, 20 to 40 parts by weight of α,β unsaturated carboxylic acid or a metal salt thereof, 0.3 to 1.8 parts by weight of a vulcanization initiator, and 0.1 to 5 parts by weight of an organic sulfur compound. The core is specified such that the content of a trans-structure after vulcanization is in a range of 10 to 50%, and letting the center hardness (JIS-C hardness) of the core be A and the surface hardness of the core be B, the value (B-A)/A is in a range of 15% or more. Such a solid golf ball, however, has a room for improvement in terms of rebound.

Golf balls using, as a main rubber component, polybutadiene containing various cis-trans-isomerizing catalysts for making the content of a trans-structure after isomerization larger than the content of the trans-structure before isomerization have been, for example, in U.S. Pat. Nos. 6,162,135, 6,291,592, 6,417,278, 6,458,895, and 6,465,578. Such golf balls, however, have a room for improvement in terms of rebound.

### SUMMARY OF THE INVENTION

In view of the foregoing, the present invention has been made, and an object of the present invention is to solve the above-described problems of the related art solid golf balls, and to provide a rubber composition for a solid golf ball, which is capable of producing a solid core exhibiting improved rebound while keeping soft hit feeling with high productivity, a method of producing the core for a solid golf ball, and a solid golf ball including the core produced by using the rubber composition for a solid golf ball.

The present inventors have examined to achieve the above object, and found that a sold golf ball capable of enhancing the initial speed upon hitting while keeping soft hit feeling can be obtained by using a core for a solid golf ball, which core is produced by using a rubber composition for a solid golf ball (hereinafter, referred to simply as “rubber composition”) having a specific composition containing polybutadiene, wherein a specific gradient of a higher-order structure (cis-structure and trans-structure) of a cross-linked polybutadiene rubber component is given in the direction from the surface of the core to the center of the core. The present inventor has thus accomplished the present invention on the basis of such knowledge.

According to a first aspect of the present invention, there is provided a rubber composition for a solid golf ball containing 100 parts by weight of a polybutadiene rubber component (A), 13 to 45 parts by weight of a co-crosslinking agent (B), 0.2 to 1.5 parts by weight of an organic peroxide (C), 2 to 30 parts by weight of a filler (D), and 0.1 to 1.5 parts by weight of an organic sulfur compound (E), wherein when a core for a solid golf ball is formed by using the rubber composition for a solid golf ball, the content of a trans-structure in a cross-linked polybutadiene rubber component on the surface of the core is in a range of 20 to 39%, and a value obtained by subtracting the content of the trans-structure in the cross-linked polybutadiene rubber component at the center of the core from the content of the trans-structure in the cross-linked polybutadiene rubber component on the surface of the core is in a range of 5 to 35%.

The core for a solid golf ball is preferably obtained by vulcanizing the rubber composition for a solid golf ball at 145 to 180° C. for 10 to 25 min.

The polybutadiene rubber component (A) is preferably polybutadiene having 80% or more of a cis-structure.

The organic sulfur compound (E) is preferably one kind or two or more kinds selected from a group consisting from thiophenols, mercaptans, and SH-group containing organic compounds.

The organic sulfur compound (E) is preferably one kind or two or more kinds selected from a group consisting from diphenyl sulfides, pentachlorothiophenols, and zinc salts thereof.

According to a second aspect of the present invention, there is provided a golf ball including a core produced from the rubber composition for a solid golf ball according to the first aspect of the present invention and one cover layer or two or more cover layers formed so as to cover the core.

According to a third aspect of the present invention, there is provided a method of producing a core for a solid golf ball, including the steps of preparing a rubber composition for a solid golf ball containing 100 parts by weight of a polybutadiene rubber component (A), 13 to 45 parts by weight of a co-crosslinking agent (B), 0.2 to 1.5 parts by weight of an organic peroxide (C), 2 to 30 parts by weight of a filler (D), and 0.1 to 1.5 parts by weight of an organic sulfur compound (E), and vulcanizing the rubber composition at 145 to 180° C. for 10 to 25 min, thereby forming a core, wherein the content of a trans-structure in a cross-linked polybutadiene rubber component on the surface of the core is in a range of 20 to 39%, and a value obtained by subtracting the content of the trans-structure in the cross-linked polybutadiene rubber component at the center of the core from the content of the trans-structure in the cross-linked polybutadiene rubber component on the surface of the core is in a range of 5 to 35%.

The polybutadiene rubber component (A) is preferably polybutadiene having 80% or more of a cis-structure.

The organic sulfur compound (E) is preferably one kind or two or-more kinds selected from a group consisting from thiophenols, mercaptans, and SH-group containing organic compounds.

The organic sulfur compound (E) is preferably one kind or two or more kinds selected from a group consisting from diphenyl sulfides, pentachlorothiophenols, and zinc salts thereof.

### DETAILED DESCRIPTION OF THE PREFERRED EMBODIMENTS

The present invention will now be described in detail.

A rubber composition for a solid golf ball according to the present invention contains a polybutadiene rubber component (A), a co-crosslinking agent (B), an organic peroxide (C), a filler (D), and an organic sulfur compound (E).

The polybutadiene rubber component (A) preferably contains polybutadiene rubber having 80 or more of a cis-structure. The polybutadiene rubber component (A) may be blended with natural rubber, polyisoprene rubber, styrene rubber, and the like without departing from the scope of the present invention, as needed.

The polybutadiene rubber component (A) is exemplified by a commercial product, for example, selected from those available from JSR Corporation under the trade names of BR01, BR02LL, BR10, BR11, BR15, and BR18, among which BR01 and BR11 are preferable from the viewpoint of rebound and workability.

The co-crosslinking agent (B) may be an unsaturated carboxylic acid or a metal salt thereof.

Examples of unsaturated carboxylic acids include acrylic acid, methacrylic acid, maleic acid, and fumaric acid, among which acrylic acid and methacrylic acid are preferable.

A metal salt of an unsaturated carboxylic acid is not particularly limited but may be selected from those obtained by neutralizing the above-described unsaturated carboxylic acids with desired metal ions. Examples of metal salts of unsaturated carboxylic acids include zinc salts, magnesium salts, and calcium salts of methacrylic acid and acrylic acid, among which zinc acrylate is preferable.

The co-crosslinking agent (B) is exemplified by a commercial product available from Nippon Distillation Industry Co., Ltd.

The blended amount of the component (B) to 100 parts by weight of the component (A) may be in a range of 13 parts by weight or more, preferably, 20 parts by weight or more, more preferably, 25 parts by weight, with the upper limit being 45 parts by weight or less, preferably, 40 parts by weight or less, more preferably, 30 parts by weight or less. If the blended amount is too large, the hardness of the resultant golf ball may become too high, thereby significantly degrading the hit feeling of the ball, whereas if the blended amount is too small, the rebound of the ball may be reduced.

Examples of the organic peroxides (C) include dicumyl peroxide, t-butyl peroxybenzoate, t-butyl cumyl peroxide, 1,1-bis(t-butylperoxy)3,3,5-trimethylcyclohexane, among which dicumyl peroxide and 1, 1-bis(t-butylperoxy)3,3,5-trimethylcyclohexane are preferable.

The organic peroxide (C) is exemplified by a commercial product, for example, selected from those available from NOF Corporation under the trade names of Percumyl D and Perhexa 3M. These organic peroxides may be used singly or in combination of two or more kinds.

The blended amount of the component (C) to 100 parts by weight of the component (A) may be in a range of 0.2 part by weight or more, preferably, 0.6 part by weight, more preferably, 0.8 part by weight, with the upper limit being in a range of 1.5 parts by weight or less, preferably, 1.4 parts by weight or less, more preferably, 1.2 parts by weight or less, most preferably, 1.0 part by weight or less. If the blended amount is too large or small, it fails to obtain desirable hit feeling, durability, and rebound of the resultant golf ball.

Examples of the fillers (D) include zinc oxide, zinc carbonate, barium sulfate, calcium carbonate, silica, and titanium dioxide, among which zinc oxide is preferable. These fillers may be used singly or in combination of two or more kinds. It is to be noted that if an unsaturated carboxylic acid is used as the co-crosslinking agent, zinc oxide must be used as the filler (D).

The blended amount of the component (D) to 100 parts by weight of the component (A) may be in a range of 2 parts by weight or more, preferably, 5 parts by weight or more, more preferably, 10 parts by weight or more, most preferably, 15 parts by weight or more, with the upper limit being in a range of 30 parts by weight or less, more preferably, 25 parts by weight or less, most preferably, 20 parts by weight or less. If the blended amount is too large or small, it fails to optimize the weight of the resultant golf ball and to obtain desirable rebound thereof.

The organic sulfur compound (E) may be selected from thiophenols and metal salts thereof, mercaptans and metal salts thereof, SH-group containing organic compounds and metal salts thereof, and sulfides.

Examples of thiophenols and metal salts thereof include pentachloro thiophenol, pentafluoro thiophenol, pentabromo thiophenol, and parachloro thiophenol, and zinc salts of pentachloro thiophenol, pentafluoro thiophenol, pentabromo thiophenol, and parachloro thiophenol, among which pentachloro thiophenol and the zinc salt of pentachloro thiophenol are preferable.

Examples of mercaptans and metal salts thereof include hexylmercaptan, and nonylmercaptan, and zinc salts of hexylmercaptan, and nonylmercaptan.

Examples of SH-group containing organic compounds and metal salts thereof include 2-thiophenthiol, 3,4,5-trichloro-2-thiophenthiol, 2-furanthiol, and 3,4,5-trichloro-2-furanthiol, and zinc salts of 2-thiophenthiol, 3,4,5-trichloro-2-thiophenthiol, 2-furanthiol, and 3,4,5-trichloro-2-furanthiol.

Examples of sulfides include diphenyl disulfide, ditolyl disulfide, dixylyl disulfide, bis(4-methacryloyl thiophenyl)sulfide, 4,4′-dibromophenyl sulfide, morpholine disulfide, di(2-thienyl)disulfide, and bis(3,4,5-trichloro-2-thienyl)disulfide, among which diphenyl disulfide is preferable.

The blended amount of the component (E) to 100 parts by weight of the component (A) is in a range of 0.1 part by weight or more, preferably, 0.3 part by weight or more, more preferably, 0.5 part by weight or more, most preferably, 0.6 part by weight or more, with the upper limit being in a range of 1.5 parts by weight or less, preferably, 1.4 parts by weight or less, more preferably, 1.2 parts by weight or less, most preferably, 1.1 parts by weight or less. Even if the blended amount is too large, the blending effect is saturated, whereas if the blended amount is too small, the blending effect is insufficient.

The rubber composition of the present invention may be further blended with other additives such as a metal oxide, an antioxidant, a dispersant, a working assist, and a vulcanizing assist in suitable amounts without departing from the scope of the present invention, as needed.

A core for a solid golf ball, which is obtained by using the rubber composition for a solid golf ball according to the present invention, mainly contains a cross-linked polybutadiene rubber formed by cross-linking of polybutadiene of the component (A), wherein the cross-linked polybutadiene rubber is specified such that the content of a trans-structure on the surface of the core is in a range of 20 to 39%, and a value obtained by subtracting the content of the trans-structure at the center of the core from the content of the trans-structure on the surface of the core is in a range of 5 to 35%.

The term “content of the trans-structure” as used herein means the percentage content of a trans-1,4-structure to the total content of a cis-1,4-structure, the trans-1-4-structure, and a 1,2-structure in the cross-linked polybutadiene rubber. The content of the trans-structure can be determined by an analysis method such as NMR (Nuclear Magnetic Resonance) or IR (Infrared Spectrometry). To be more specific, after a spectrum is obtained by the analysis such as NMR or IR, the ratio of the peak area or peak amount corresponding to the trans-1-4-structure in the spectrum to the total of the peak areas or peak amounts corresponding to the cis-1,4-structure, the trans-1,4-structure, and the 1,2-structure in the spectrum is calculated, to determine the content of the trans-structure.

The core for a solid golf ball, which is obtained by using the rubber composition for a solid golf ball according to the present invention, is preferably specified such that the content of the trans-structure in the cross-linked polybutadiene on the surface of the core is in a range of 20% or more, preferably, 22% or more, more preferably, 25% or more, with the upper limit being in a range of 39% or less, preferably, 35% or less, most preferably, 30% or less, and that the value obtained by subtracting the content of the trans-structure at the center of the core from the content of the trans-structure on the surface of the core is in a range of 5% or more, preferably, 8% or more, with the upper limit thereof being in a range of 35% or less, preferably, 25% or less, more preferably, 20% or less. The content of the trans-structure at the center of the core can be calculated by subtracting the above value (that is, the difference between the contents on the surface of the core and at the center of the core) from the content on the surface of the core. Such a content of the trans-structure at the center of the core may be specified such that the lower limit be generally in a range of 4% or more, preferably, 5% or more, more preferably, 10% or more, most preferably, 13% or more, and the upper limit be generally in a range of 34% or less, preferably, 30% or less, more preferably, 25% or less, most preferably, 20% or less. If each of the contents of the trans-structure on the surface of the core and at the center of the core is out of the above range, it fails to achieve the object of the present invention, that is, to obtain a golf ball having soft hit feeling and good rebound.

A core for a solid golf ball can be formed by using the rubber composition of the present invention in accordance with a process of kneading the above-described components of the rubber composition by a known kneader such as a Banbury mixer or a roll mill, and molding the resultant compound in a mold for a core.

According to the present invention, the core for a solid golf ball is preferably subjected to a vulcanizing treatment performed by vulcanizing the rubber composition at a vulcanizing temperature of 145 to 180° C. for a vulcanizing time of 10 to 25 min.

To be more specific, the vulcanizing temperature is generally in a range of 145° C. or more, preferably, 150° C. or more, more preferably, 155° C. or more, with the upper limit being generally in a range of 180° C. or less, preferably, 170° C. or less, more preferably, 160° C. or less. If the vulcanizing temperature is too high, the durability of the resultant core is degraded, whereas if the vulcanizing temperature is too low, the rebound and the hardness of the core are reduced.

The vulcanizing time is generally in a range of 10 min or more, preferably, 13 min or more, with the upper limit being in a range of 25 min or less, preferably, 20 min or less. If the vulcanizing time is too long, the productivity of the resultant core is degraded, whereas if the vulcanizing time is too short, the hardness of the core becomes unstable.

According to the present invention, to effectively achieve the characteristics of the core obtained by using the rubber composition for a solid golf ball according to the present invention, the diameter of the core may be in a range of 30 mm or more, preferably, 34 mm or more, with the upper limit being in a range of 42 mm or less, preferably, 40 mm or less.

The deflection of the core having the above diameter under an applied load of 100 kg may be in a range of 2.5 mm or more, preferably, 3.0 mm or more, with the upper limit being in a range of 5.0 mm or less, preferably, 4.0 mm or less.

A method of producing a core for a solid golf ball according to the present invention will be described below. The method includes the step of vulcanizing the rubber composition containing the components (A) to (E) at the above-described mixing ratio at the above-described vulcanizing temperature of 145 to 180° C. for the above-described vulcanizing time of 10 to 25 min, to produce a core for a solid golf ball. The core thus produced is specified such that the content of the trans-structure in the cross-linked polybutadiene rubber component on the surface of the core is in a range of 20 to 39%, and the value obtained by subtracting the content of the trans-structure at the center of the core from the content of the trans-structure on the surface of the core is in a range of 5 to 35%. In this way, according to the above-described vulcanizing method is specified by relatively rapidly vulcanizing the rubber composition, more specifically, vulcanizing the rubber composition in a one-step at 145 to 180° C. for 10 to 25 min, to simply give a relatively large gradient of the trans-structure in the direction from the surface of the core to the center of the core. Accordingly, the vulcanizing method according to the present invention is preferable in terms of productivity.

A solid golf ball according to the present invention can be obtained by molding the rubber composition for a solid golf ball according to the present invention into a mold, to form a core, and covering the core with one or two or more cover layers in accordance with a known method.

A cover material used for forming the cover layer may be, while not limited thereto, an ionomer resin or a polyurethane resin.

The covering method may be performed by previously forming a composition for a cover into a semi-spherical half-shell, wrapping the core with a piece of the semi-spherical half-shells, and hot-pressing the shells and the core wrapped therewith at 130 to 230° C. for 1 to 15 min, or by directly injection-molding the composition for a cover around the core.

The total thickness of the cover layers is generally in a range of 1 mm or more, preferably, 1.5 mm or more, with the upper limit being in a range of 4 mm or less, preferably, 3 mm or less. If the total thickness of the cover layers is too thick, it is difficult to make effective use of the high rebound characteristic of the core, which may shorten the flight distance of the resultant golf ball, whereas if the total thickness of the cover layers is too thin, the durability against hitting of the golf ball may be degraded.

The surface of the solid golf ball according to the present invention may have a number of dimples, or may be subjected to marking, painting, or surface treatment, as needed.

The solid golf ball according to the present invention can be produced as that for competition in accordance with the Rules of Golf. To be more specific, the solid golf ball can be formed so as to have a diameter of 42.67 mm or more and a weight of 45.93 g or less in accordance with the Rules of Golf.

### EXAMPLE

The present invention will be more fully described by way of examples, together with comparative examples, although the present invention is not limited thereto.

### Examples 1 to 3, Comparative Examples 1 to 3

Raw materials in each of compositions shown in Table 1 were kneaded at 80 to 110° C. in a non-productive rubber stage (before addition of peroxide) and at 50 to 90° C. in the productive rubber stage (after addition of peroxide) for a total kneading time of 5 min by using a test kneader (Labo Plastomill, available from Toyo Seiki Co., Ltd.). In this kneading, the rotational speed of a rotor was set to 50 rpm. The kneaded compound was then vulcanized and cured in the corresponding condition shown in Table 1, to produce a core for a solid golf ball, having a diameter of 39.2 mm. The result of evaluating the core for a solid golf ball is as shown in Table 1

TABLE 1

| | | Example | | | Comparative Example | | |
|---|---|---|---|---|---|---|---|
| | | 1 | 2 | 3 | 1 | 2 | 3 |
| Composition | BR | 100 | 100 | 100 | 100 | 100 | 100 |
| of Core | Zinc acrylate | 27 | 27 | 27 | 27 | 23 | 30 |
| Material | Zinc oxide | 20.8 | 20.3 | 21.0 | 21.0 | 22.5 | 8.0 |
| (parts by | pentachlorothiophenol | 0.5 | | | | | |
| weight) | Zinc salt of | | 1.0 | | | | |
| | pentachlorothiophenol | | | | | | |
| | diphenyl disulfide | | | 0.7 | 0.7 | | 2.0 |
| | dicumyl peroxide | 1.2 | 1.2 | 1.2 | 1.2 | 1.2 | 0.5 |
| Vulcanizing | first-step vulcanization | A | A | A | B | A | D |
| Condition | second-step vulcanization | | | | C | | |
| Evaluation | (a)(%) | 24.9 | 25.0 | 31.3 | 25.6 | 8.2 | 24.6 |
| of Core | (b)(%) | 15.5 | 15.2 | 16.9 | 22.6 | 7.5 | 20.1 |
| | [(a) − (b)](%) | 9.4 | 9.8 | 14.4 | 3.0 | 0.7 | 4.5 |
| | hardness (mm) of core | 3.57 | 3.52 | 3.61 | 3.69 | 3.56 | 4.60 |
| | initial speed (m/s) of core | 77.58 | 77.65 | 77.25 | 77.05 | 76.68 | 76.31 |

The details of the raw materials, vulcanizing condition, and evaluation of the core shown in Table 1 are as follows:

BR: Trade name, BR01 (content of cis-1,4-structure, 96%:

content of trans-1,4-structure, 2%: content of vinyl-group structure, 2%), available from JSR Corporation

Zinc Acrylate: Available from Nippon Distillation Industry Co., Ltd.

Zinc Oxide: Available from Sakai Chemical Industry Co., Ltd.

Pentachlorothiophenol: Available from Tokyo Kasei Kogyo Co., Ltd.

Diphenyl Disulfide: Available from Tokyo Kasei Kogyo Co., Ltd.

Dicumyl Peroxide: Available from NOF Corporation

Vulcanizing Condition

A, 155° C.×15 min: B, 145° C.×40 min: C, 170° C.×10 min: D, 155° C.×30 min

Evaluation of Core/(a)%, (b)%

Content of local trans-structure obtained by calculating the result, measured by the ATR (Attenuated Total Reflection) method using FT-IR (Fourier Transform Infrared Spectroscopy), by the Morero method [(a), content of trans-structure on surface of core: (b), content of trans-structure at center of core]

Hardness (mm) of Core

Deflection of core under applied load of 100 kg (A larger value indicates a softer core).

Initial Speed (m/s) of Core

Measured by initial speed meter of the same type as that specified under authorized organ, USGA.

The core in each of Examples 1 to 3, in which the content of the trans-structure on the surface of the core is suitable and the difference between the content of the trans-structure on the surface of the core and the content of the trans-structure at the center of the core is suitable, is desirable in terms of initial speed upon hitting the core.

The core in Comparative Example 1, in which the content of the trans-structure on the surface of the core is suitable but the difference between the content of the trans-structure on the surface of the core and the content of the trans-structure at the center of the core is unsuitable, is undesirable in terms of initial speed upon hitting the core. The core in Comparative Example 1 is also undesirable in that since the vulcanizing time is long, the productivity is poor.

The core in Comparative Example 2, in which the content of the trans-structure on the surface of the core is unsuitable and the difference between the content of the trans-structure on the surface of the core and the content of the trans-structure at the center of the core is unsuitable, is undesirable in terms of initial speed upon hitting the core.

The core in Comparative Example 3, in which the content of the trans-structure on the surface of the core is unsuitable and the difference between the content of the trans-structure on the surface of the core and the content of the trans-structure at the center of the core is unsuitable, is undesirable in terms of initial speed upon hitting the core. In addition, the core in Comparative Example 3 is too low in hardness, that is, too soft because the content of the organic sulfur compound is unsuitable.

As described above, the core for a solid golf ball, which is produced by using the rubber composition for a solid golf ball according to the present invention, is advantageous in including a suitable content of the trans-structure on each of the surface of the core and at the center of the core. The solid golf ball according to the present invention, which is produced by using such a core, is advantageous being excellent in hit feeling because of the use of the soft core and also excellent in flight characteristics. The method of producing a core for a solid golf ball according to the present invention is advantageous in simply producing the core having the above-described excellent characteristics.

While the preferred embodiments of the present invention have been described using specific terms, such description is for illustrative purposes only, and it is to be understood that changes and variations may be made without departing from the spirit or scope of the following claims.

1. A rubber composition for a solid golf ball containing 100 parts by weight of a polybutadiene rubber component (A), 13 to 45 parts by weight of a co-crosslinking agent (B), 0.2 to 1.5 parts by weight of an organic peroxide (C), 2 to 30 parts by weight of a filler (D), and 0.1 to 1.5 parts by weight of an organic sulfur compound (E);
wherein when a core for a solid golf ball is formed by using said rubber composition for a solid golf ball, the content of a trans-structure in a cross-linked polybutadiene rubber component on the surface of said core is in a range of 20 to 39%, and a value obtained by subtracting the content of the trans-structure in the cross-linked polybutadiene rubber component at the center of said core from the content of the trans-structure in the cross-linked polybutadiene rubber component on the surface of said core is in a range of 5 to 35%.

2. A rubber composition for a solid golf ball according to claim 1, wherein said core for a solid golf ball is obtained by vulcanizing said rubber composition for a solid golf ball at 145 to 180° C. for 10 to 25 min.

3. A rubber composition for a solid golf ball according to claim 1, wherein said polybutadiene rubber component (A) is polybutadiene having 80% or more of a cis-structure.

4. A rubber composition for a solid golf ball according to claim 1, wherein said organic sulfur compound (E) is one kind or two or more kinds selected from a group consisting from thiophenols, mercaptans, and SH-group containing organic compounds.

5. A rubber composition for a solid golf ball according to claim 1, wherein said organic sulfur compound (E) is one kind or two or more kinds selected from a group consisting from diphenyl sulfides, pentachlorothiophenols, and zinc salts thereof.

6. A golf ball comprising a core produced from a rubber composition for a solid golf ball according to claim 1 and one cover layer or two or more cover layers formed so as to cover said core.

7. A method of producing a core for a solid golf ball, comprising the steps of:
preparing a rubber composition for a solid golf ball containing 100 parts by weight of a polybutadiene rubber component (A), 13 to 45 parts by weight of a co-crosslinking agent (B), 0.2 to 1.5 parts by weight of an organic peroxide (C), 2 to 30 parts by weight of a filler (D), and 0.1 to 1.5 parts by weight of an organic sulfur compound (E); and
vulcanizing the rubber composition at 145 to 180° C for 10 to 25 min, thereby forming a core;
wherein the content of a trans-structure in a cross-linked polybutadiene rubber component on the surface of the core is in a range of 20 to 39%, and a value obtained by subtracting the content of the trans-structure in the cross-linked polybutadiene rubber component at the center of the core from the content of the trans-structure in the cross-linked polybutadiene rubber component on the surface of the core is in a range of 5 to 35%.

8. A method of producing a core for a solid golf ball according to claim 7, wherein said polybutadiene rubber component (A) is polybutadiene having 80% or more of a cis-structure.

9. A method of producing a core for a solid golf ball according to claim 7, wherein said organic sulfur compound (E) is one kind or two or more kinds selected from a group consisting from thiophenols, mercaptans, and SH-group containing organic compounds.

10. A method of producing a core for a solid golf ball according to claim 7, wherein said organic sulfur compound (E) is one kind or two or more kinds selected from a group consisting from diphenyl sulfides, pentachlorothiophenols, and zinc salts thereof.
